(19) United States
(12) Patent Application Publication
(10) Pub. No.: US 2016/0179713 A1
(43) Pub. Date: Jun. 23, 2016

(54) SEMICONDUCTOR INTEGRATED CIRCUIT AND DEVICE DETECTION SYSTEM PROVIDED WITH THE SAME

(71) Applicant: Panasonic Intellectual Property Management Co., Ltd., Osaka (JP)

(72) Inventors: DAISUKE MATSUOKA, Osaka (JP); TETSURO YOSHIMOTO, Osaka (JP)

(21) Appl. No.: 15/053,771

(22) Filed: Feb. 25, 2016

Related U.S. Application Data
(63) Continuation of application No. PCT/JP2014/004297, filed on Aug. 21, 2014.

(30) Foreign Application Priority Data
Sep. 13, 2013 (JP) 2013-190914

(51) Int. Cl. G06F 13/22; G06F 13/40; G06F 1/32; G06F 13/10

(52) U.S. Cl. CPC G06F 13/22; G06F 13/102; G06F 13/4068; G06F 1/3203

(57) ABSTRACT

Provided is a semiconductor integrated circuit capable of reducing power consumption while continuously detecting presence of connection of a device. The semiconductor integrated circuit includes: a first pad including a detection pad and a communication pad; a plurality of IO cells each having a high-withstand voltage device which receives a voltage of the detection pad and the communication pad, and a low-withstand voltage device which outputs a voltage obtained after the voltage is stepped down. Furthermore, the semiconductor integrated circuit includes a main circuit capable of detecting the connection of the device based on a voltage output from the IO cell connected to the detection pad, and performing data communication with the device; and a sub-circuit that is connected to the high-withstand voltage device included in the IO cell connected to the detection pad, and detects the connection of the device based on a voltage of the detection pad.

### BACKGROUND OF THE INVENTION

1. Field of the Invention

The present disclosure relates to a semiconductor integrated circuit, and more particularly to a technology of reducing power consumption.

2. Description of the Related Art

Conventionally, in a system where a personal computer or the like and a device are connected, there is known a technology of performing data communication between the personal computer or the like and the device. PTL 1 discloses a technology in which data communication and the like between a personal computer and a CD-ROM (Compact Disc Read Only Memory) drive are possible in a case where the personal computer and the CD-ROM drive are connected, while a power supply of the CD-ROM drive is turned off in a case where the CD-ROM drive is removed from the personal computer.

Generally, in the system, reduction in power consumption is often desired for a purpose of utilization for a longer time, and therefore there is a case where power consumption is reduced by stop of power supply to a functional block whose operation is unnecessary in a plurality of functional blocks installed in the system. For example, in a case where the device is not connected, operation of a functional block for performing data communication with the device is unnecessary, and therefore power supply to this functional block is cut off, so that power consumption can be reduced.

However, such a system is provided with a function for detecting connection of a device in order to start data communication with the device, in a case where the device is connected, and it is necessary to continuously enable this function.

In the system that performs data communication with the device, a low withstand voltage transistor that is driven at a low voltage in order to increase an operation speed is often used in a semiconductor integrated circuit as various functional blocks. On the other hand, in a part that performs communication with an outside, a high withstand voltage transistor that is driven at a high voltage is used from the viewpoint of consistency with an existing system and an interface standard. Therefore, a voltage applied to a pad connected to the device is stepped down by an IO cell connected to the pad, and then is supplied to various functional blocks. Then, after a process by the various functional blocks, the voltage is boosted by the IO cell to be output from the pad. That is, in a semiconductor integrated circuit configuring a data communication function or a device detection function, a low withstand voltage transistor is used.

### CITATION LIST

### Patent Literature

PTL 1: Unexamined Japanese Patent Publication No. H11-313440 However, a leakage current of the low withstand voltage transistor is relatively large, and therefore continuous operation of the device detection function using the low withstand voltage transistor causes increase in power consumption of the semiconductor integrated circuit. As a result, reduction in power consumption of the entire system is hindered.

### SUMMARY OF THE INVENTION

The invention has been made in view of the above point, and an object of the present disclosure is to provide a semiconductor integrated circuit capable of reducing power consumption while continuously detecting presence of connection of a device.

In order to solve the above problem, the following solutions are provided by the present disclosure. That is, a semiconductor integrated circuit capable of detecting presence of connection of a device, and performing data communication with the device includes: a first pad including a detection pad for detecting presence of connection between the semiconductor integrated circuit and the device, and a communication pad for performing data communication with the device; a plurality of first IO cells, each of which being connected to the detection pad or the communication pad, and having a high-withstand voltage device which receives a voltage of the pad, and a low-withstand voltage device which outputs a voltage obtained after the voltage received by the high-withstand voltage device is stepped down; a main circuit that is connected to the low-withstand voltage device of each of the first IO cells, is capable of detecting the presence of the connection of the device based on a voltage output from the IO cells connected to the detection pad, and is capable of performing data communication with the device through the first IO cell connected to the communication pad in a case where the detection result shows that the device is connected; and a sub-circuit that is connected to a high-withstand voltage device included in the first IO cell connected to the detection pad, and detects the presence of the connection of the device based on a voltage of the detection pad.

Consequently, the main circuit is connected to the detection pad and the communication pad through the IO cells, is capable of detecting the presence of the connection of the device, and is capable of performing data communication through the IO cell connected to the communication pad in a case where the device is connected. Additionally, voltages of the detection pad and the communication pad are stepped down by the IO cells, and supplied to the main circuit.

Accordingly, in the main circuit, a low withstand voltage transistor operable at a voltage lower than the voltages of the detection pad and the communication pad can be used. Operation of the low withstand voltage transistor is faster than operation of a high withstand voltage transistor, and therefore it is possible to increase a speed of a process related to the data communication with the device, for example. Additionally, the main circuit can detect the device base on a voltage stepped down by the IO cell.

On the other hand, a voltage of potential equal to a voltage of the detection pad is supplied to the sub-circuit. Accordingly, in the sub-circuit, a high withstand voltage transistor operable at the voltage of the detection pad can be used. Additionally, the sub-circuit can detect the connection of the device based on the voltage of the detection pad.

For example, in the semiconductor integrated circuit capable of performing data communication with the device, in a case where the device is not connected, it is not necessary to enable a function of data communication, and therefore the function is stopped, so that it is possible to reduce power consumption. However, in case the device is connected, and data communication with the device is performed, a function for detecting the connection of the device is desirably continuously enabled. Conventionally, in a circuit having the device detection function, the low withstand voltage transistor is used, and therefore when this detection function is continuously enabled, power consumption is increased due to leakage current characteristics of the low withstand voltage transistor.

In contrast, in the semiconductor integrated circuit according to the present disclosure, the main circuit and the sub-circuit that use different withstand voltage transistors can each detect the connection of the device. For example, the main circuit can detect the connection of the device in a case where operation of the main circuit is necessary, and the sub-circuit can detect the connection of the device in a case where operation of the main circuit is not necessary. Consequently, it is possible to continuously detect the connection of the device.

Generally, a leakage current of the high withstand voltage transistor is smaller than a leakage current of the low withstand voltage transistor. Accordingly, when power supply to the main circuit using the low withstand voltage transistor is stopped, and a device detection function by the sub-circuit using the high withstand voltage transistor is enabled, power consumption of the main circuit is reduced, and a leakage current in the sub-circuit can be suppressed. Therefore, it is possible to effectively reduce power consumption.

In a case where the connection of the device of the sub-circuit is detected, power supply to the main circuit may be started.

The sub-circuit may have the device detection function, and therefore the sub-circuit does not need a clock used for performing data communication with a device. That is, the sub-circuit does not need a functional block for processing the clock, and therefore it is possible to configure the sub-circuit by a relatively simple circuit, and it is possible to further reduce power consumption.

In a device detection system having the above semiconductor integrated circuit, the semiconductor integrated circuit includes: a second IO cell having a low-withstand voltage device that receives a signal showing a detection result by the main circuit, and a high-withstand voltage device that outputs a voltage obtained after the voltage received by the low-withstand voltage device is boosted; and a second pad capable of outputting the voltage output from the high-withstand voltage device of the second IO cell outside the semiconductor integrated circuit. Furthermore, output as a detection result by the sub-circuit is connected to the high-withstand voltage device included in the second IO cell connected to the second pad. The device detection system includes a control circuit that performs on-control of power supplied to the main circuit in a case where a signal from the second pad shows that the device is connected.

Consequently, for example, in a case where the semiconductor integrated circuit is not connected to the device and power is not supplied to the main circuit, when the sub-circuit detects the connection of the device, the control circuit can supply power to the main circuit. That is, the device is connected to the semiconductor integrated circuit, so that the main circuit can automatically start operation. Additionally, the semiconductor integrated circuit capable of reducing power consumption is used, so that it is possible to reduce power consumption of the device detection system.

According to the present disclosure, it is possible to provide a semiconductor integrated circuit capable of reducing power consumption while continuously detecting presence of connection of a device.

### BRIEF DESCRIPTION OF DRAWINGS

FIG. 1 is a configuration diagram of a semiconductor integrated circuit according to a first exemplary embodiment;

FIG. 2 is a configuration diagram illustrating a specific example of an IO cell;

FIG. 3 is a configuration diagram of a device detection system according to a second exemplary embodiment;

FIG. 4 is a configuration diagram of a device detection system according to a modification of the second exemplary embodiment;

FIG. 5 is a configuration diagram illustrating a specific example of a sub-circuit;

FIG. 6 is a configuration diagram illustrating a specific example of a state detection circuit;

FIG. 7 is another configuration diagram illustrating a specific example of a sub-circuit;

FIG. 8 is another configuration diagram illustrating the specific example of the sub-circuit;

FIG. 9 is another configuration diagram illustrating the specific example of the sub-circuit;

FIG. 10A is a configuration diagram illustrating a specific example of a filter circuit;

FIG. 10B is a configuration diagram illustrating the specific example of the filter circuit;

FIG. 11 is a configuration diagram illustrating a main part of an LSI including an ESD protection circuit;

FIG. 12 is another configuration diagram of the specific example of the ESD protection circuit in FIG. 11;

FIG. 13 is a configuration diagram illustrating the main part of the LSI configured such that a value to be latched is stably determined;

FIG. 14 is a configuration diagram illustrating a specific example of a latch circuit;

FIG. 15 is a detailed circuit diagram of the latch circuit in FIG. 14;

FIG. 16 is another configuration diagram illustrating a specific example of the latch circuit;

FIG. 17 is a detailed circuit diagram of the latch circuit in FIG. 16;

FIG. 18 is another configuration diagram of a specific example of the latch circuit;

FIG. 19 is a detailed circuit diagram of the latch circuit in FIG. 18;

FIG. 20 is another configuration diagram illustrating a specific example of the latch circuit;

FIG. 21 is a detailed circuit diagram of the latch circuit in FIG. 20;

FIG. 22 is a configuration diagram of a device detection system according to a third exemplary embodiment; and

FIG. 23A is a configuration diagram illustrating a specific example of a secondary ESD protection circuit in FIG. 22.

FIG. 23B is a configuration diagram illustrating a specific example of a secondary ESD protection circuit in FIG. 22.

### DETAILED DESCRIPTION OF THE PREFERRED EMBODIMENTS

### First Exemplary Embodiment

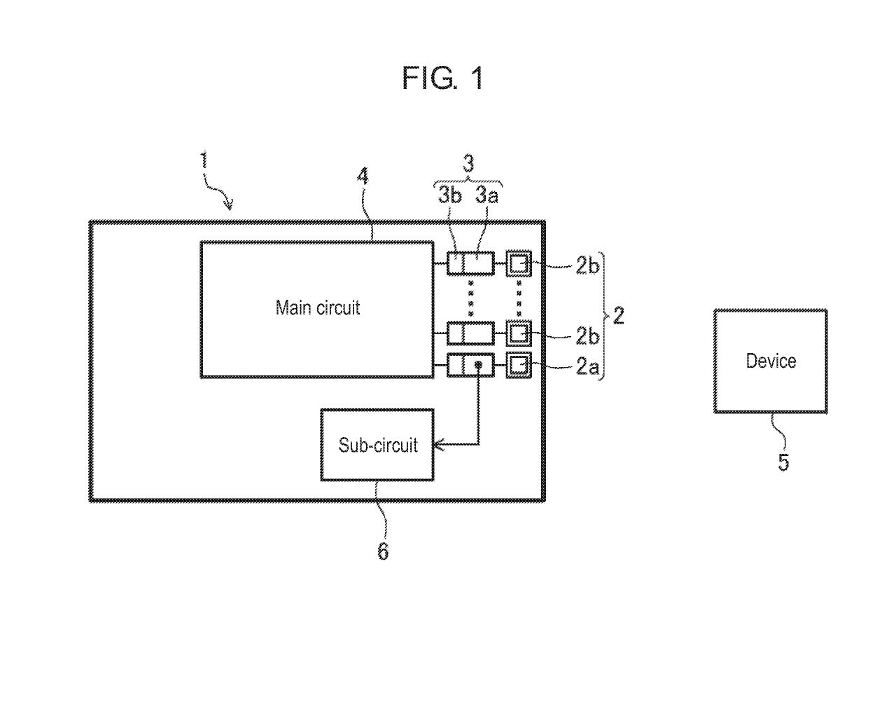

FIG. 1 is a configuration diagram of a semiconductor integrated circuit according to a first exemplary embodiment. Semiconductor integrated circuit 1 (hereinafter, referred to as LSI 1) according to this exemplary embodiment is installed in, for example, a personal computer, detects whether or not device 5 such as an SD card is inserted into a card slot of the personal computer, and enables data communication with device 5.

LSI 1 has a plurality of first pads 2 (hereinafter, simply referred to as pads 2), a plurality of first IO cells 3 (hereinafter, simply referred to as IO cells 3), main circuit 4, and sub-circuit 6.

Pads 2 have detection pads 2a used for detecting whether or not device 5 is connected to LSI 1, and communication pads 2b used for performing data communication with device 5. A number of detection pads 2a and a number of communication pads 2b are arbitrary.

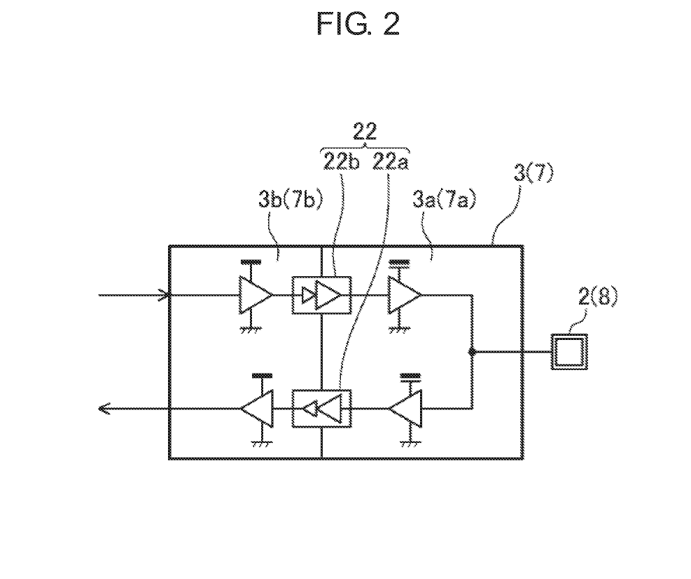

IO cells 3 are configured so as to step down voltages applied to pads 2 to output the voltages. IO cells 3 each include high-withstand voltage device 3a that is connected to pad 2 and that receives a voltage of pad 2, level shift circuit 22 (FIG. 2) that transforms the voltage received by high-withstand voltage device 3a, and low-withstand voltage device 3b that outputs the voltage transformed by level shift circuit 22. Pads 2 may have a pad other than the above. In this case, an IO cell corresponding to the pad may be provided.

FIG. 2 is a configuration diagram illustrating a specific example of the IO cell. In FIG. 2, each high-withstand voltage device 3a is connected to pad 2, and can be configured by, for example, a high withstand voltage transistor of 3.3 V. Additionally, each low-withstand voltage device 3b is connected to high-withstand voltage device 3a through level shift circuit 22, and can be configured by, for example, a low withstand voltage transistor of 1.1 V. IO cell 3 is configured as illustrated in FIG. 2, so that it is possible to transform a voltage between high-withstand voltage device 3a and low-withstand voltage device 3b through level shift circuits 22

Level shift circuit 22 can be configured by level-down circuit 22a that steps down a voltage of high-withstand voltage device 3a to output the voltage to low-withstand voltage device 3b, and level-up circuits 22b that boosts a voltage of low-withstand voltage device 3b to output the voltage to high-withstand voltage device 3a. Consequently, while a voltage of pad 2 can be stepped down through high-withstand voltage device 3a, level-down circuit 22a, and low-withstand voltage device 3b, a voltage of main circuit 4 can be boosted through low-withstand voltage device 3b, level-up circuit 22b, and high-withstand voltage device 3a

In each IO cell 3, in a case where only an input function is required, an output function may be omitted. In each IO cell 3, in a case where only the output function is required, the input function may be omitted. That is, IO cell 3 may include an IO cell having only one function of input and output functions.

Returning to FIG. 1, main circuit 4 is connected to low-withstand voltage devices 3b included in IO cells 3. Main circuit 4 has a functional block capable of detecting whether or not device 5 is connected to LSI 1 based on a voltage output from low-withstand voltage devices 3b of IO cells 3 connected to detection pads 2a. Additionally, main circuit 4 has a functional block capable of performing data communication with device 5 by use of a predetermined protocol through IO cells 3 connected to communication pads 2b and communication pads 2b, in a case where the connection of device 5 is detected. Voltages of pads 2 are stepped down by IO cells 3, to be supplied to main circuit 4.

Main circuit 4 may have a functional block other than the above functional blocks.

Sub-circuit 6 is connected to high-withstand voltage device 3a included in IO cell 3 connected to detection pad 2a. Sub-circuit 6 has a functional block capable of detecting whether or not device 5 is connected to LSI 1 based on the voltage of detection pad 2a.

As described above, main circuit 4 is connected to low-withstand voltage devices 3b, and therefore a low withstand voltage transistor is used in each functional block of main circuit 4. On the other hand, sub-circuit 6 is connected to high-withstand voltage device 3a, and therefore a high withstand voltage transistor can be used in the functional block of the device detection of sub-circuit 6. In other words, sub-circuit 6 and IO cell 3 can share a circuit having high-withstand voltage device 3a.

An example of operation of LSI 1 according to this exemplary embodiment will be described. In LSI 1, main circuit 4 and sub-circuit 6 are exclusively operable.

Specifically, in a case where a power supply of main circuit 4 is in an ON state, LSI 1 operates in a normal mode. At this time, each functional block of main circuit 4 is operable. Accordingly, when device 5 is connected to LSI 1, main circuit 4 can detect the connection of the device, and perform a process such as data communication with device 5. At this time, a function of detecting device 5 in sub-circuit 6 may not be enabled.

On the other hand, in a case where the power supply of main circuit 4 is in an OFF state, LSI 1 operates in a standby mode. At this time, operation of each functional block of main circuit 4 stops, power is supplied to sub-circuit 6. Accordingly, a detection function of device 5 by sub-circuit 6 is enabled, and therefore the connection of device 5 is detectable by sub-circuit 6. In a case where sub-circuit 6 detects the connection of device 5 in the standby mode, the power supply of main circuit 4 may be controlled to be in the ON state, namely LSI 1 may be controlled to be in the normal mode.

Thus, in LSI 1, main circuit 4 or sub-circuit 6 can continuously detect that device 5 is connected.

Generally, in the personal computer, such a state that the personal computer is not used for a fixed time is continued, or a user performs operation for a power saving mode, so that control for shifting from the normal mode to the standby mode is possible. In the standby mode, in order to reduce power consumption, a power supply of an unnecessary functional block of a plurality of functional blocks installed in the personal computer is controlled to be turned off. However, when the device such as an SD card is connected to the personal computer, operation for returning the personal computer from the standby mode to the normal mode is performed in order to data communication and the like with the SD card. Therefore, in the personal computer or the like, regardless of an operation mode, a functional block that detects whether or not the SD card is connected needs to be continuously operated.

Conventionally, in each functional block mounted on the semiconductor integrated circuit, the low withstand voltage transistor is often used from the viewpoint of increase in an operation speed and the like. Accordingly, the functional block that detects connection of a device is configured by the low withstand voltage transistor. However, a leakage current of the low withstand voltage transistor is relatively large, and therefore there is a possibility that a large power is consumed when the functional block that detects the connection of the device is continuously operated. Conventionally, the device detection function configured by the low withstand voltage transistor needs to be continuously enabled regardless of the operation mode of the semiconductor integrated circuit. Therefore, particularly in the standby mode, reduction in power consumption is hindered by the leakage current of the low withstand voltage transistor.

In contrast, in LSI 1 according to this exemplary embodiment, the low withstand voltage transistor can be used in main circuit 4, and the high withstand voltage transistor can be used in sub-circuit 6, so that a circuit enabling the device detection function can be switched in accordance with the operation mode of LSI 1. The leakage current of the high withstand voltage transistor is smaller than the leakage current of the low withstand voltage transistor, and therefore even when the functional block that detects device 5 is enabled in sub-circuit 6, it is possible to effectively reduce power consumption. Particularly, in a case where LSI 1 is in the standby mode, the power supply of main circuit 4 is turned off, so that power consumption in main circuit 4 is reduced, and a leakage current in sub-circuit 6 is reduced.

In a case where sub-circuit 6 detects connection of device 5, for example, a user may be notified of the connection or the like, to supply power to main circuit 4 by an operation of the user. Additionally, power may be controlled to be automatically supplied to main circuit 4 in response to a result that sub-circuit 6 detects the connection of device 5.

As described above, according to this exemplary embodiment, voltages of pads 2 are stepped down to be supplied to main circuit 4, and a voltage of pad 2 is supplied to sub-circuit 6. Accordingly, the low withstand voltage transistor can be used in main circuit 4, and the high withstand voltage transistor can be used in sub-circuit 6.

In LSI 1, main circuit 4 and sub-circuit 6 can detect device 5, and a circuit that detects device 5 is switchable between main circuit 4 and sub-circuit 6.

Consequently, it is possible to configure LSI 1 that can effectively reduce power consumption while continuously detecting presence of the connection of device 5. Particularly, in the standby mode, the detection function of device 5 by sub-circuit 6 configured by the high withstand voltage transistor is simply enabled, and therefore it can be said that a reduction effect of power consumption is high.

In LSI 1 according to this exemplary embodiment, main circuit 4 performs a process such as data communication with device 5, and therefore it is necessary to deal with a clock of a high frequency inside main circuit 4, but such a clock is unnecessary to sub-circuit 6. Additionally, in a case where sub-circuit 6 detects presence of connection of the SD card by a mechanical switch, like as SD card slot of the personal computer or the like, a chattering elimination circuit or the like is configured as an analog circuit, so that the clock can be unnecessary.

Consequently, it is possible to reduce power consumption. Additionally, in sub-circuit 6, an operating voltage of the high withstand voltage transistor may be lowered up to a degree of an operating voltage of the low withstand voltage transistor. In this case, the leakage current of the high withstand voltage transistor can be further suppressed.

### Second Exemplary Embodiment

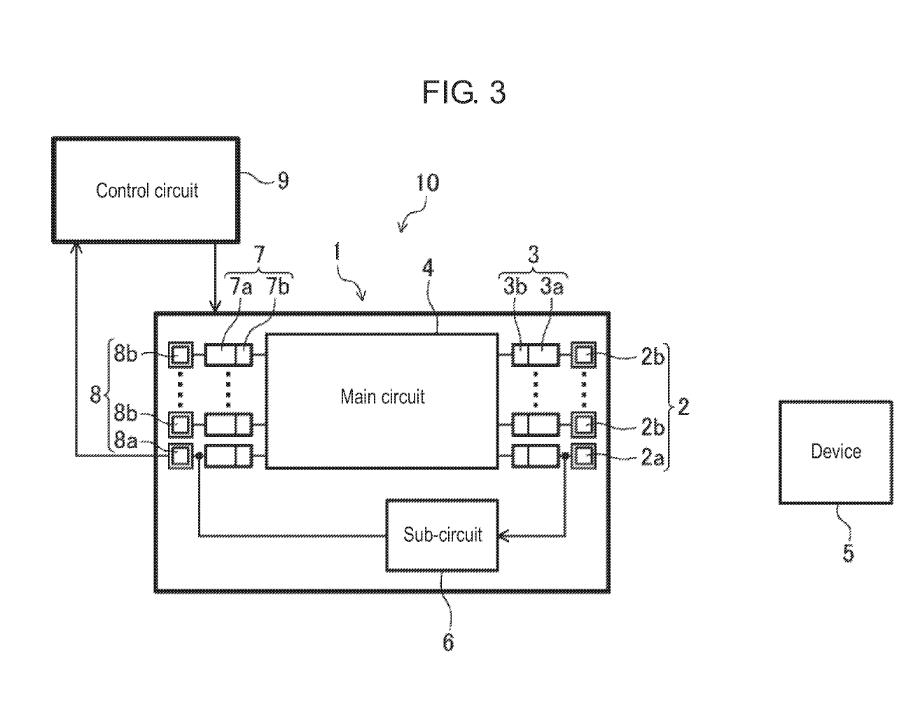

FIG. 3 is a configuration diagram of a device detection system according to a second exemplary embodiment. This device detection system 10 has LSI 1 of FIG. 1, and control circuit 9.

In LSI 1 according to this exemplary embodiment, an operation mode is automatically switchable from a standby mode to a normal mode by connection of device 5. As to a configuration of LSI 1, different points between the first exemplary embodiment and the second exemplary embodiment will be mainly described.

LSI 1 has second IO cells 7 (hereinafter, simply referred to as IO cells 7), and second pads 8 (hereinafter, simply referred to as pads 8). As illustrated in FIG. 2, IO cells 7 have low-withstand voltage devices 7b that receive output of main circuit 4, level shift circuits 22 (level-up circuits 22b) that boost voltages received by low-withstand voltage devices 7b, and high-withstand voltage devices 7a that output voltages boosted by level shift circuits 22 to pads 8. Each of low-withstand voltage devices 7b can be configured by, for example, a low withstand voltage transistor of 1.1 V. Additionally, each of high-withstand voltage devices 7a can be configured by, for example, a high withstand voltage transistor of 3.3 V.

Returning to FIG. 3, pads 8 are configured to be able to output voltages of high-withstand voltage devices 7a of IO cells 7 to outside of LSI 1. Pads 8 include, for example, pads 8a corresponding to detection pads 2a, and pads 8b corresponding to communication pads 2b. A number of pads 2 and a number of pads 8 may be different.

In a case where output of pads 8 (pads 8a) shows that device 5 is connected by sub-circuit 6 when LSI 1 is in a standby mode, control circuit 9 controls so as to start power supply to LSI 1.

Sub-circuit 6 is connected between detection pad 2a and IO cell 3, and between pad 8a and IO cell 7. That is, sub-circuit 6 may be connected to voltages of potential equal to voltages of pads 2 and pads 8. Consequently, a functional block included in sub-circuit 6 can be configured by a high withstand voltage transistor.

A case where LSI 1 shifts from the standby mode to a normal mode in device detection system 10 according to this exemplary embodiment will be described.

In a case where LSI 1 is in the standby mode, power supply to main circuit 4 is stopped, power is supplied to sub-circuit 6, and a function for detecting device 5 in sub-circuit 6 is operated. In this state, when device 5 is connected to pads 2 of LSI 1, sub-circuit 6 detects the connection of device 5 through detection pad 2a, and this detection result is output to pad 8a.

Pad 8a outputs the output from sub-circuit 6 to control circuit 9. Control circuit 9 controls so as to start power supply to LSI 1 based on the output of pad 8a. Consequently, main circuit 4 operates, and LSI 1 automatically shifts to the normal mode.

Thus, in device detection system 10 according to this exemplary embodiment, when device 5 is connected to LSI 1, LSI 1 returns from the standby mode to the normal mode, so that data communication with device 5 is enabled.

In the standby mode, a power supply of main circuit 4 is in an OFF state, and a function for detecting device 5 in sub-circuit 6 is operated. Additionally, as described above, the high withstand voltage transistor can be used in sub-circuit 6. A leakage current of the high withstand voltage transistor is relatively small, and therefore it is possible to reduce power consumption of sub-circuit 6 in the standby mode. As a result, it is possible to implement reduction in power consumption of entire device detection system 10

### —Modification 1—

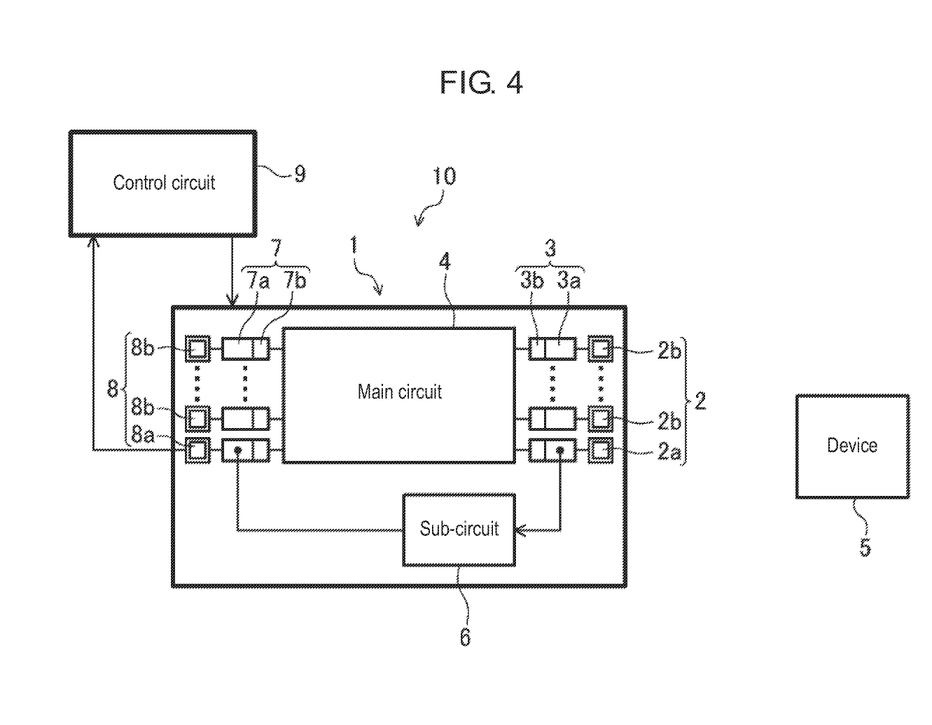

FIG. 4 is a configuration diagram illustrating a modification of a device detection system according to the second exemplary embodiment. Like LSI 1 of device detection system 10 illustrated in FIG. 4, sub-circuit 6 may be connected between high-withstand voltage device 3a of IO cell 3 and high-withstand voltage device 7a of IO cell 7. With this configuration, a high withstand voltage transistor used in sub-circuit 6 can be shared with at least one of high-withstand voltage devices 3a, 7a of IO cells 3 and IO cells 7. Consequently, it is possible to reduce an area of LSI 1.

### Configuration Example of Sub-Circuit

A configuration example of the above sub-circuit 6 will be described.

### —Configuration Example 1—

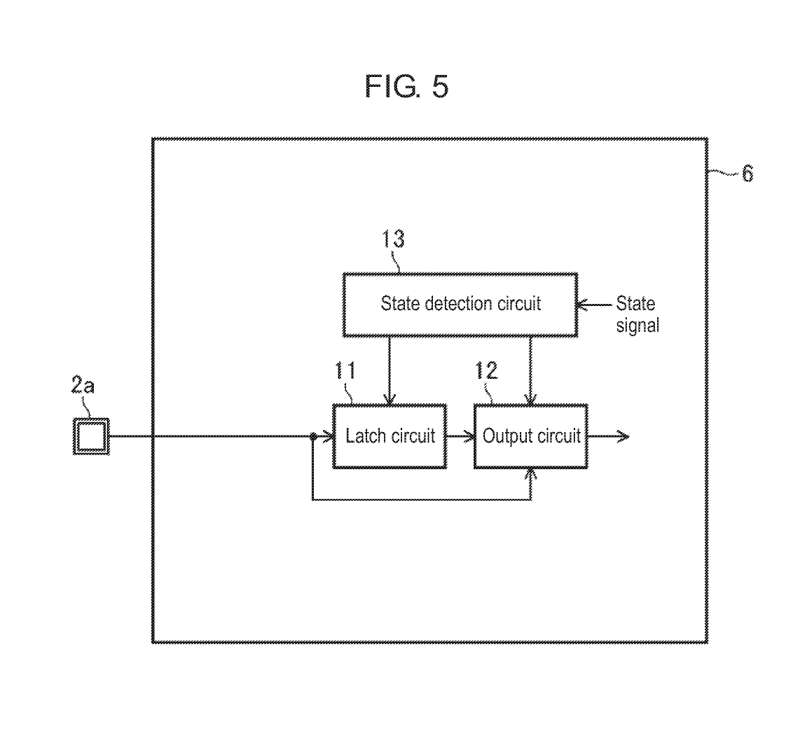

FIG. 5 is a configuration diagram illustrating a specific example of a sub-circuit. Sub-circuit 6 has latch circuit 11, output circuit 12, and state detection circuit 13. In FIG. 5, IO cells 3 are omitted.

Latch circuit 11 latches a voltage of detection pad 2a when the power supply of main circuit 4 is in an ON state (LSI 1 is in a normal mode), and holds a latched value when the power supply of main circuit 4 is in an OFF state (LSI 1 is in a standby mode).

When the power supply of main circuit 4 is in the OFF state, output circuit 12 determines presence of connection of device 5 based on the voltage of detection pad 2a and the value held by latch circuit 11. Then, when the determination result shows that device 5 is connected, output circuit 12 activates output. On the other hand, when the determination result shows that device 5 is not connected, output circuit 12 inactivates the output. Additionally, when the power supply of main circuit 4 is in an ON state, output circuit 12 inactivates the output.

Specifically, in a case where the voltage of detection pad 2a and the value of latch circuit 11 are different, output circuit 12 determines that device 5 is connected, and activates the output. That is, when device 5 is connected, output circuit 12 may be configured to output a signal showing that device 5 is connected.

For example, in LSI 1 according to the first exemplary embodiment, a user may be notified that device 5 is connected, by the signal from output circuit 12. Consequently, the user can confirm that device 5 is connected to LSI 1, and can turn on the power supply of main circuit 4.

In LSI 1 according to the second exemplary embodiment, the signal from output circuit 12 is output from pad 8 to control circuit 9. Consequently, device 5 is connected to LSI 1, so that an operation mode of LSI 1 can be automatically shifted from the standby mode to the normal mode.

State detection circuit 13 receives a state signal showing whether LSI 1 is in the normal mode or in the standby mode, and outputs a value shown by the state signal to latch circuit 11 and output circuit 12. That is, state detection circuit 13 is configured to notify latch circuit 11 and output circuit 12 of the operation mode of LSI 1.

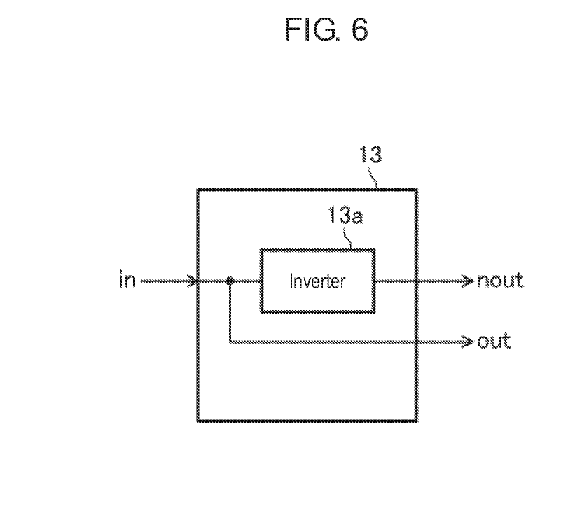

FIG. 6 is a configuration diagram illustrating a specific example of the state detection circuit. State detection circuit 13 has, for example, an inverter 13a to which a signal in showing the power supply of main circuit 4, as the state signal, is input. When the signal in is on, state detection circuit 13 sets signal out as output to an H level, and sets signal nout as output to an L level. Additionally, when the signal in is off, state detection circuit 13 sets signal out as output to the L level, and sets signal nout as output to the H level. Rising and falling of signal in are, for example, several μs to dozens ms order.

### —Configuration Example 2—

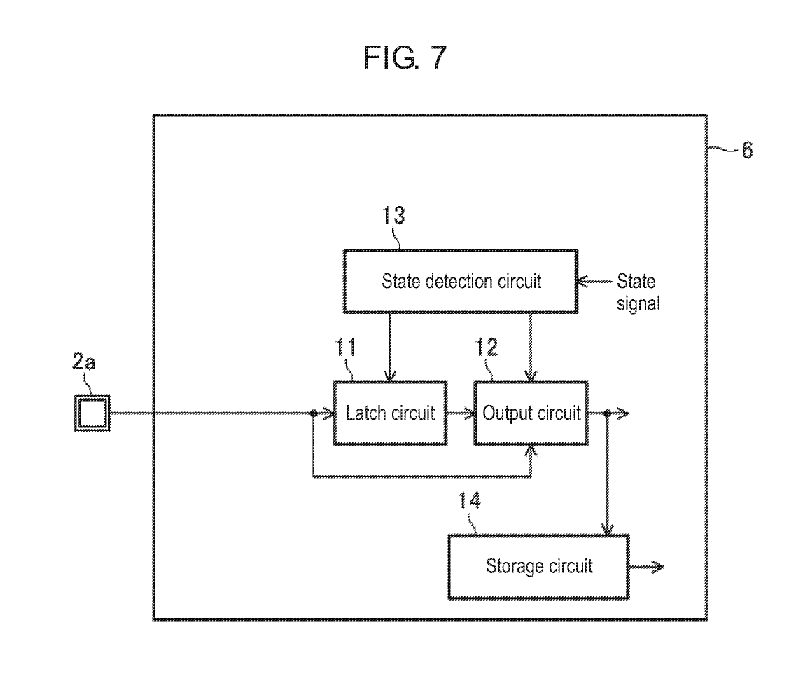

FIG. 7 is another configuration diagram illustrating the specific example of the sub-circuit. Differences between FIG. 5 and FIG. 7 will be mainly described.

Sub-circuit 6 has storage circuit 14 that stores output of output circuit 12. Storage circuit 14 is configured to be able to output a content stored by storage circuit 14.

In addition to the case where LSI 1 automatically shifts from a standby mode to a normal mode by connection of device 5, there is a case where, for example, a user turns on a power supply to LSI 1, so that LSI 1 sometimes shifts to the normal mode. In both cases, LSI 1 is in the normal mode, but processes in main circuit 4 are sometimes different. For example, even when LSI 1 is in the normal mode, in a case where device 5 is not connected, the data communication function of main circuit 4 may not be operated.

Accordingly, main circuit 4 can desirably determine what event causes LSI 1 to shift to the normal mode. Consequently, main circuit 4 can perform a suitable process in accordance with an event. For example, in a case where device 5 is connected and LSI 1 shifts to the normal mode, main circuit 4 can perform a necessary process on a communications protocol for data communication.

Thus, when storage circuit 14 stores the output of output circuit 12, LSI 1 can determine whether or not LSI 1 shifts to the normal mode, by the connection of device 5.

### —Configuration Example 3—

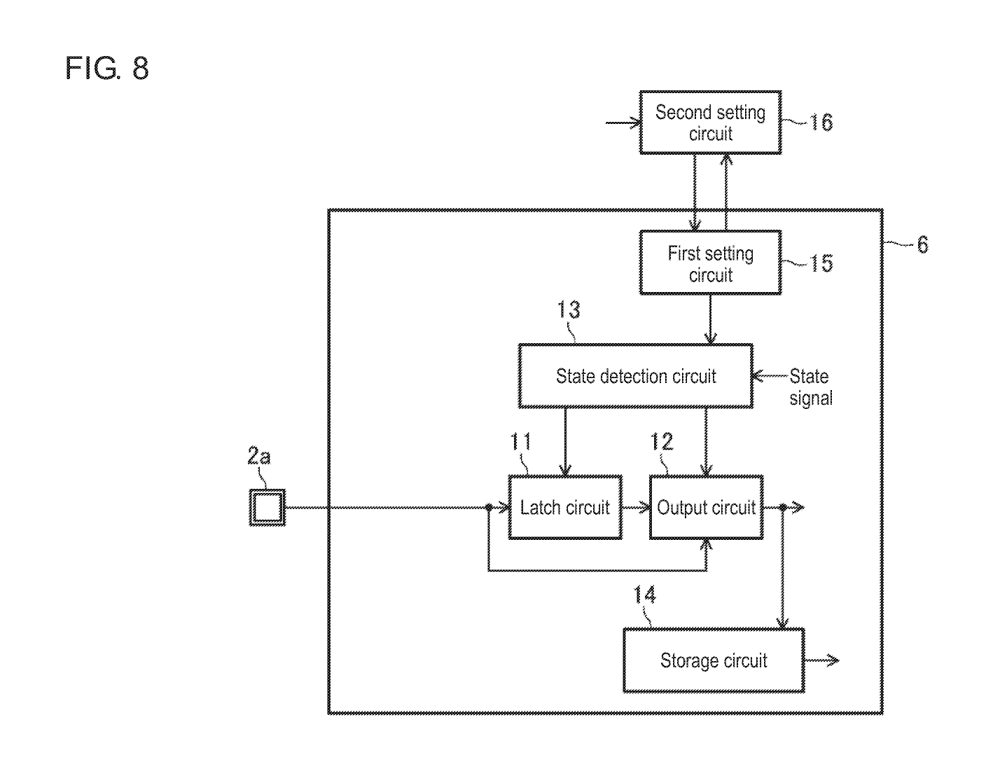

FIG. 8 is another configuration diagram illustrating the specific example of the sub-circuit. Differences between FIG. 7 and FIG. 8 will be mainly described.

Sub-circuit 6 has a first setting circuit 15 that is capable of setting a value for inactivating output of output circuit 12, even in a case where device 5 is connected.

In FIG. 8, second setting circuit 16 is provided in, for example, main circuit 4. In a case where second setting circuit 16 receives a value to be set to first setting circuit 15, second setting circuit 16 sets the value to second setting circuit 16, and outputs the value to first setting circuit 15.

State detection circuit 13 is configured to be able to output a set value of first setting circuit 15 to output circuit 12. First setting circuit 15 and output circuit 12 may be connected.

In a case where the value for inactivating output of output circuit 12 is set to first setting circuit 15, output circuit 12 inactivates the output even when connection of device 5 is detected.

Power is continuously supplied to sub-circuit 6, even when LSI 1 is in the normal mode or in the standby mode, and therefore first setting circuit 15 can hold the set value, and state detection circuit 13 can output the set value to output circuit 12. Additionally, in a case where LSI 1 is in the normal mode, a value set to second setting circuit 16 is set to first setting circuit 15.

Consequently, the same values are set to first and second setting circuits 15, 16. When LSI 1 is in the standby mode, a power supply of main circuit 4 is in an OFF state, the set value of second setting circuit 16 is lost. Therefore, when LSI 1 shifts from the standby mode to the normal mode, the set values are synchronized between first and second setting circuits 15, 16, so that second setting circuit 16 can hold the same set value as the set value of first setting circuit 15.

For example, when an SD card is inserted into an SD card slot of a personal computer which is in a standby mode, the personal computer returns to a normal mode. However, there is a case that the personal computer may be kept in the standby mode, even when the SD card is inserted.

In order to implement this, some of OSs (operating system) of the personal computers can set so as not to return to the normal mode, even when the SD card is inserted.

As illustrated in FIG. 8, the value for inactivating output of output circuit 12 is set to first setting circuit 15, so that LSI 1 can be made not to shift to the normal mode even when LSI 1 in the standby mode is connected to device 5. Consequently, it is possible to reduce power consumption, and therefore the personal computer with LSI 1 installed therein can continue the standby mode for a longer period.

### —Configuration Example 4—

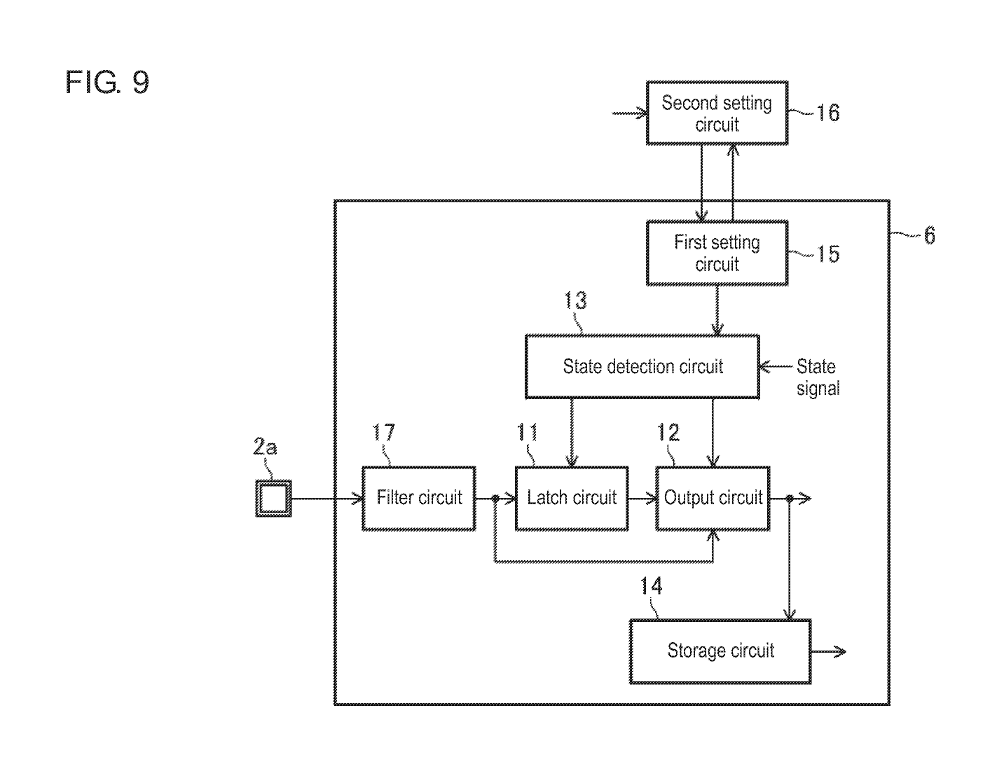

FIG. 9 is another configuration diagram illustrating the specific example of the sub-circuit. Differences between FIG. 8 and FIG. 9 will be mainly described.

Sub-circuit 6 has filter circuit 17. Filter circuit 17 is provided between detection pad 2a and latch circuit 11, and eliminates an excessive frequency component included in a voltage input from detection pad 2a to latch circuit 11. Filter circuit 17 can be configured by, for example, a low pass filter.

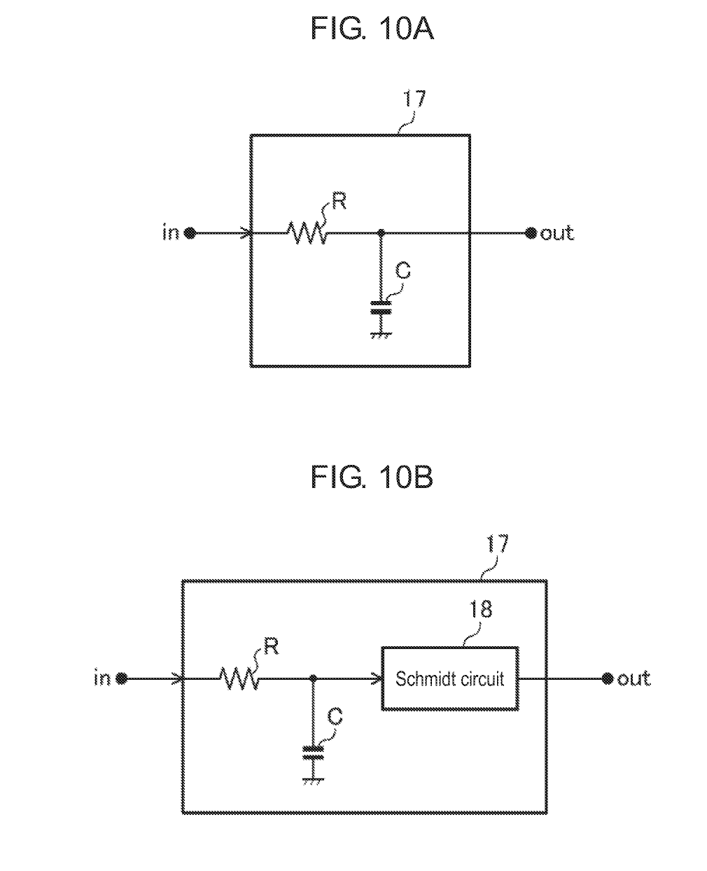

FIG. 10A, FIG. 10B each are a configuration diagram illustrating a specific example of a filter circuit. Filter circuit 17 illustrated in FIG. 10A has resistive element R connected between input terminal in and output terminal out, and capacitive element C connected between resistive element R and a ground. Input terminal in is connected to detection pads 2a, and output terminal out is connected to latch circuit 11 and output circuit 12.

Filter circuit 17 may be configured as illustrated in FIG. 10B. Specifically, Schmidt circuit 18 may be connected between resistive element R and output terminal out.

For example, in a case where an SD card as device 5 is inserted into a personal computer with LSI 1 installed therein, a mechanical switch is used for detection of the insertion. Therefore, there is a possibility that chattering noise is generated when the SD card is inserted and removed. However, filter circuit 17 illustrated in FIG. 9, FIG. 10A, and FIG. 10B is provided so that chattering noise can be eliminated.

As described above, the several configuration examples of sub-circuit 6 have been described. However, in each of the above exemplary embodiments, ESD protection circuit 19 for protecting an internal circuit of LSI 1 from ESD (Electro-Static-Discharge) applied to pads 2 may be provided.

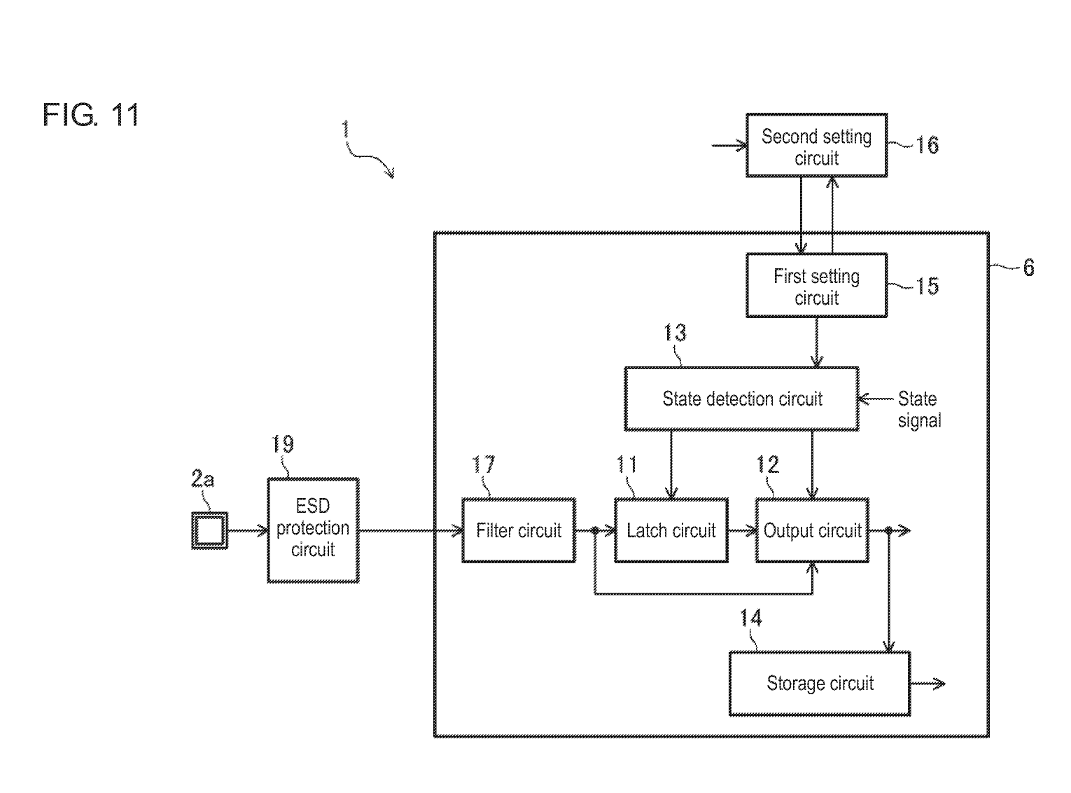

FIG. 11 is a configuration diagram illustrating a main part of an LSI including an ESD protection circuit. Differences between FIG. 9 and FIG. 11 will be mainly described. As illustrated in FIG. 11, in LSI 1 according to each of the above exemplary embodiments, for example, ESD protection circuit 19 may be provided between detection pad 2a and filter circuit 17. ESD protection circuit 19 may be shared with main circuit 4.

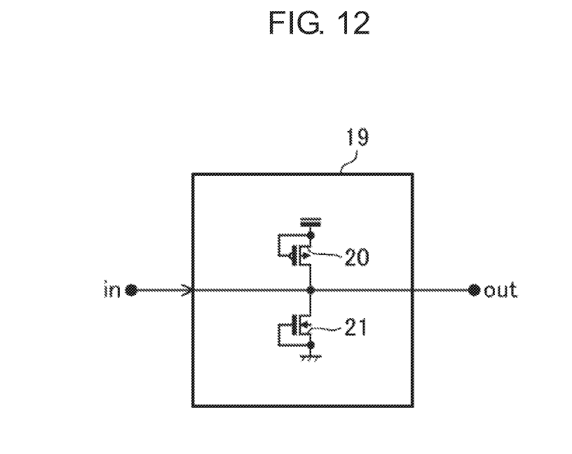

FIG. 12 is another configuration diagram of the specific example of the ESD protection circuit. ESD protection circuit 19 has, for example, PMOS (Positive Channel Metal Oxide Semiconductor) transistor 20 and NMOS (Negative Channel MOS) transistor 21 that are connected in series between a power supply voltage and a ground. A connecting point of PMOS transistor 20 and NMOS transistor 21 is connected between input terminal in and output terminal out.

Input terminal in is connected to detection pad 2a, and output terminal out is connected to an input side of filter circuit 17.

As described above, ESD protection circuit 19 is provided, so that it is possible to protect main circuit 4 and sub-circuit 6.

LSI 1 may be configured such that a value to be latched by latch circuit 11 of sub-circuit 6 is stably determined. Hereinafter, such a case will be described.

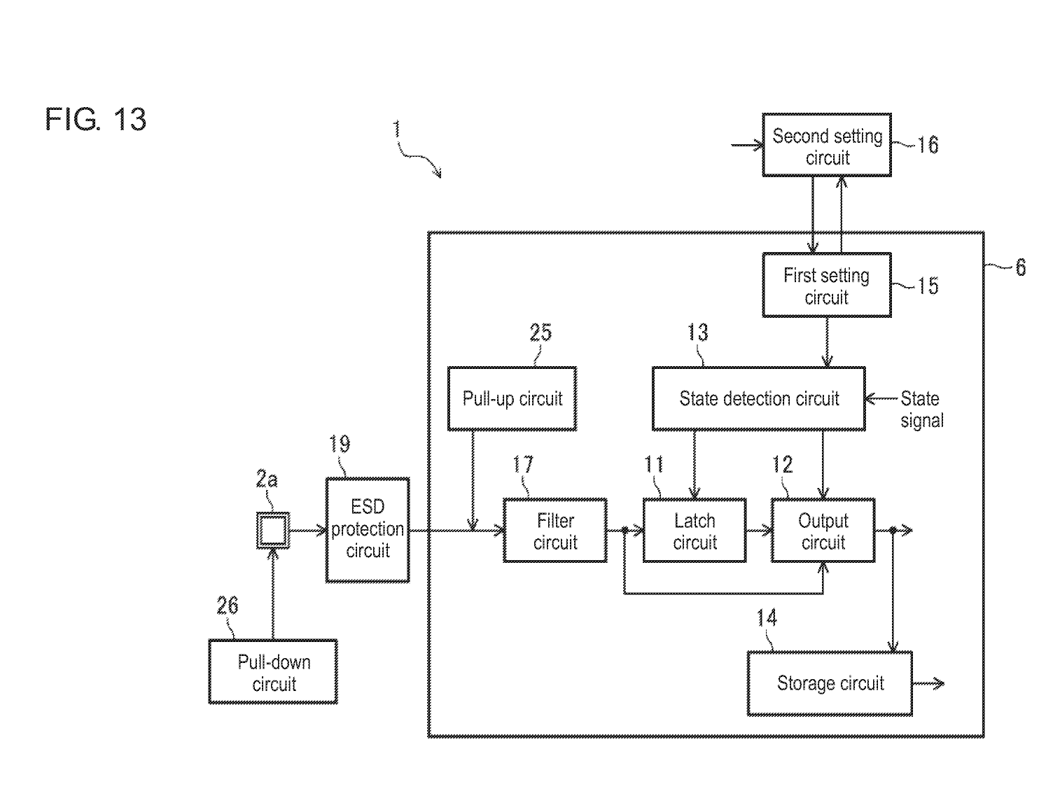

FIG. 13 is a configuration diagram illustrating the main part of the LSI configured such that the value to be latched is stably determined. Differences between FIG. 11 and FIG. 13 will be mainly described.

Sub-circuit 6 has pull-up circuit 25 capable of pulling up a voltage of detection pad 2a. For example, pull-up circuit 25 may pull up potential between ESD protection circuit 19 and filter circuit 17 to predetermined potential.

The voltage of detection pad 2a can be pulled down by pull-down circuit 26. Pull-down circuit 26 can be configured by, for example, a mechanical switch. That is, LSI 1 and device detection system 10 may have a configuration in which pull-down circuit 26 can pull down the voltage of detection pad 2a.

For example, in FIG. 13, when the SD card as device 5 is connected, the mechanical switch as pull-down circuit 26 is turned on. Consequently, the voltage of detection pad 2a is pull down to an L level. On the other hand, in a case where the SD card is not connected, the mechanical switch is in an OFF state, and therefore pull-up circuit 25 pulls up the voltage of detection pad 2a to an H level.

As described above, the voltage of detection pad 2a is pulled up or pulled down in accordance with insertion and removal of SD card with respect to the mechanical switch, so that it is possible to stably determine a logical value of latch circuit 11.

### [Configuration Example of Latch Circuit]

A configuration example of latch circuit 11 described above will be described. Latch circuit 11 may be configured to latch a voltage of detection pad 2a in a case where LSI 1 is in a normal mode, and to hold the latched value in a case where LSI 1 is in a standby mode.

### —Configuration Example 1—

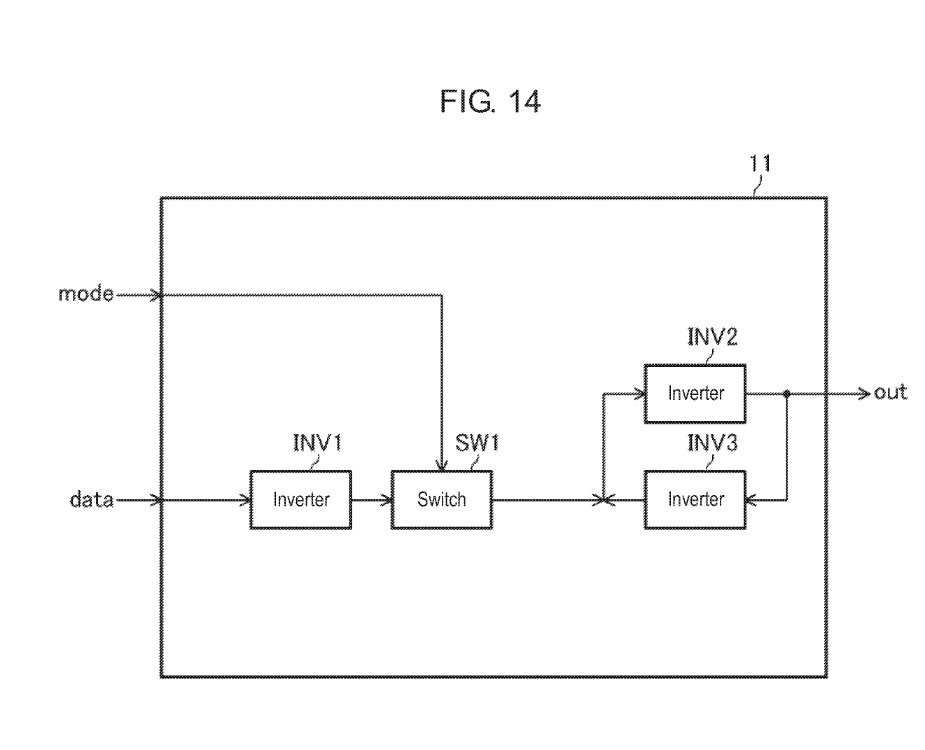

FIG. 14 is a configuration diagram illustrating a specific example of the latch circuit.

Latch circuit 11 has inverters INV1, INV2, INV3, and switch SW1. In FIG. 14, signal data is a voltage of detection pad 2a, signal out is output from latch circuit 11 to output circuit 12. Signal mode is a state signal, and is a signal showing an operation mode of LSI 1.

Inverter INV1 inverts signal data to output the inverted signal data. When the power supply of main circuit 4 is in an ON state (signal mode is, for example, an H level), Switch SW1 is turned on. On the other hand, when the power supply of main circuit 4 is in an OFF state (signal mode is, for example, an L level), Switch SW1 is turned off.

Additionally, inverter INV2 as a first inverter, inverter INV3 as a second inverter latch signal data.

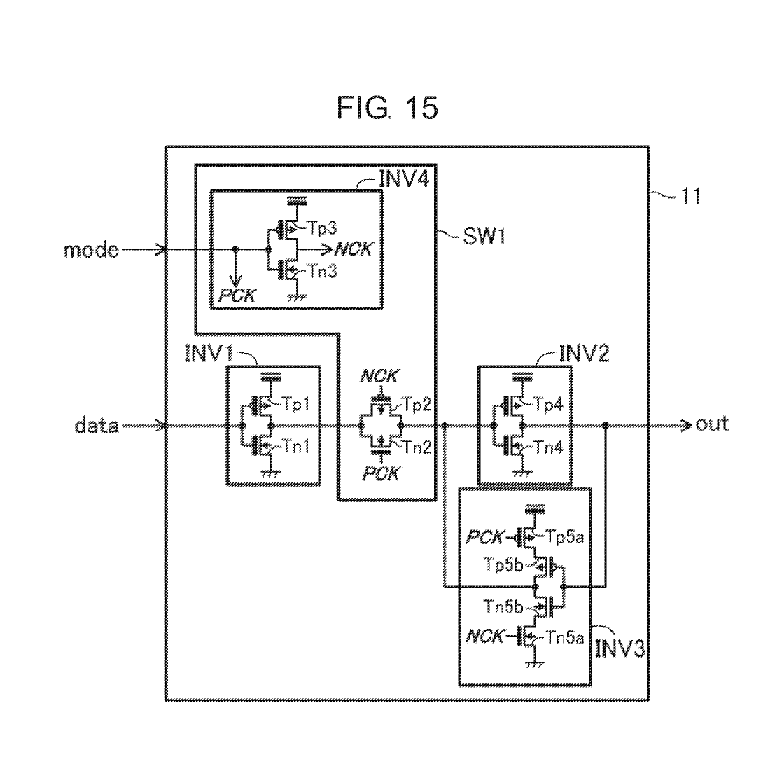

FIG. 15 is an example of a detailed circuit diagram of FIG. 14.

Inverter INV1 can be configured by PMOS transistor Tp1 and NMOS transistor Tn1.

Switch SW1 has inverter INV4 that generates and outputs signal PCK from signal mode and signal NCK obtained by inverting signal PCK, PMOS transistor Tp2 that has a gate which receives signal NCK, and NMOS transistor Tn2 that has a gate which receives signal PCK. Inverter INV4 can be configured by PMOS transistor Tp3 and NMOS transistor Tn3.

Inverter INV2 can be configured by PMOS transistor Tp4 and NMOS transistor Tn4.

Inverter INV3 can be configured by PMOS transistor Tp5a that has a gate which receives signal PCK, NMOS transistor Tn5a that has a gate which receives signal NCK, and PMOS transistor Tp5b and NMOS transistor Tn5b that are connected in series between transistors Tp5a and Tn5a.

In inverters INV2, INV3 configuring latch, output of inverter INV3 is stopped when switch SW1 is in an ON state, in order to avoid collision of a signal in writing.

### —Configuration Example 2—

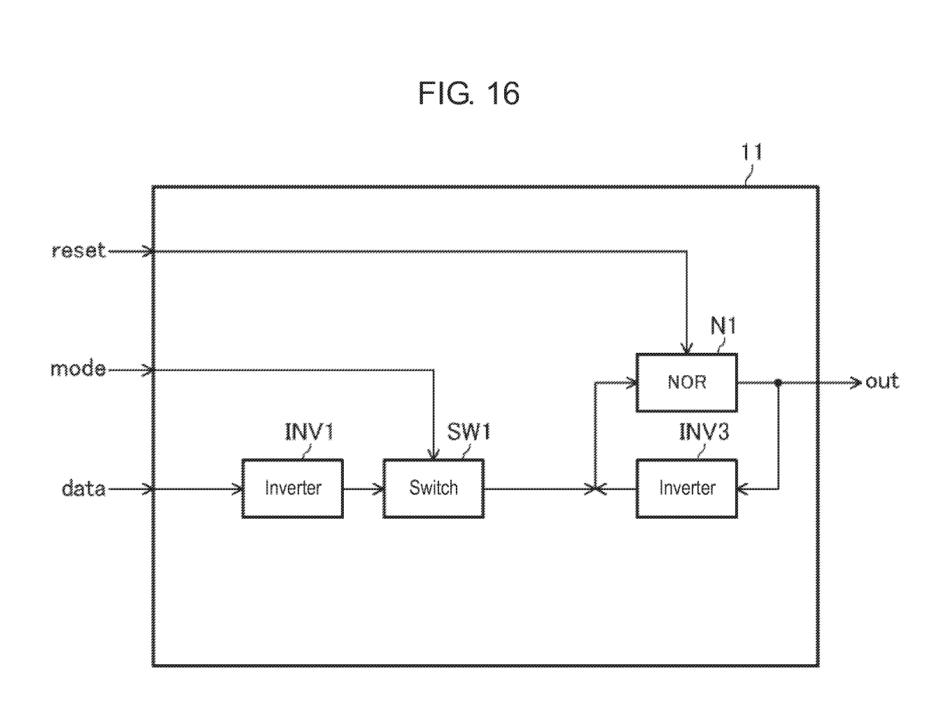

FIG. 16 is an example of another configuration diagram illustrating a specific example of the latch circuit. Differences between FIG. 14 and FIG. 16 will be described.

Latch circuit 11 illustrated in FIG. 16 is configured to enable resetting by reset signal reset (hereinafter, referred to as signal reset).

Specifically, latch circuit 11 is configured such that 2-input NOR circuit N1 and inverter INV3 latch signal data. In NOR circuit N1, signal reset is controlled, so that it is possible to determine a logical value to be latched.

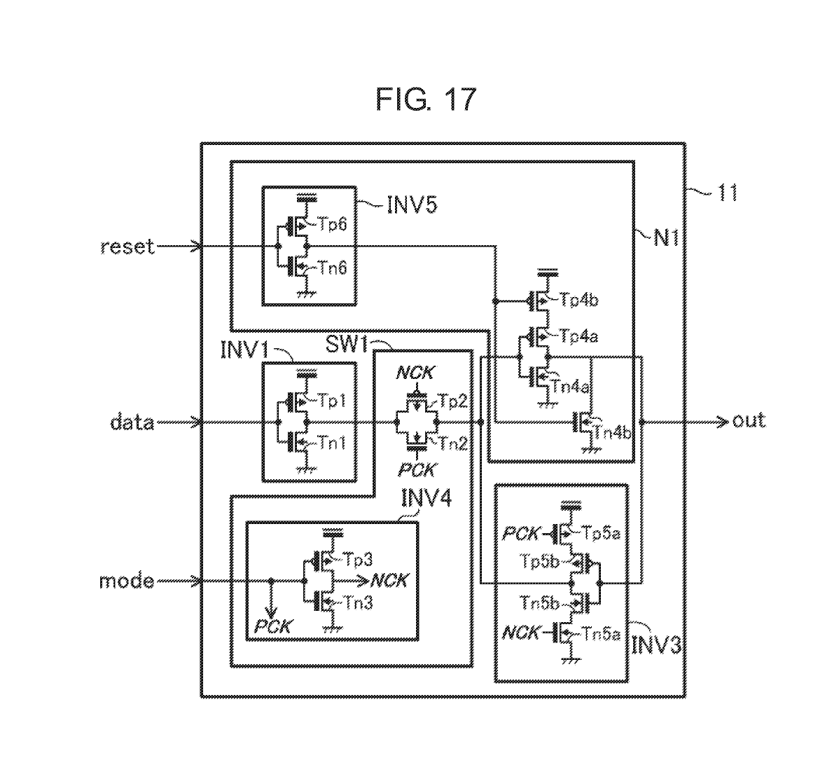

FIG. 17 is a detailed circuit diagram of FIG. 16. Differences between FIG. 15 and FIG. 17 will be mainly described.

Latch circuit 11 has NOR circuit N1 in place of inverter INV2 illustrated in FIG. 15. NOR circuit N1 can be configured by inverter INV5 that inverts signal reset, PMOS transistor Tp4a and NMOS transistor Tn4a that have gates which receive output of switch SW1, PMOS transistor Tp4b and NMOS transistor Tn4b that have gates which receive output of inverter INV5.

Inverter INV5 can be configured by PMOS transistor Tp6 and NMOS transistor Tn6.

Thus, resettable latch circuit 11 is configured, so that it is possible to determine the logical value to be latched, and it is possible to suppress a through current.

Latch circuit 11 of this configuration example can forcibly set signal out to an L level in a case where signal reset is at an L level. However, latch circuit 11 may be configured to set signal out to an H level.

### —Configuration Example 3—

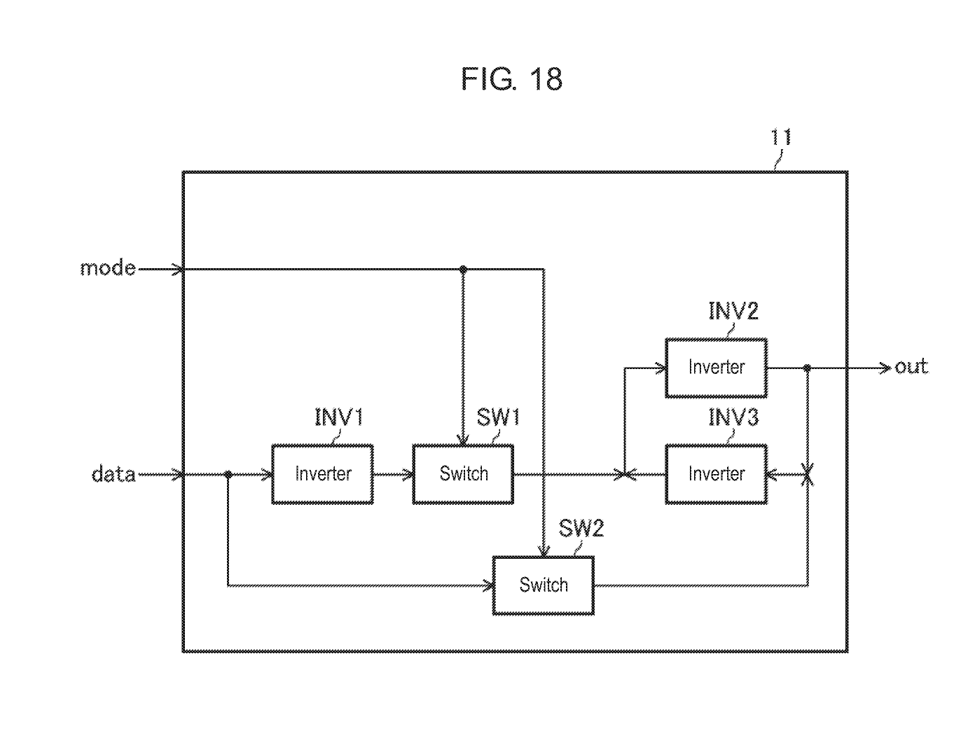

FIG. 18 is an example of another configuration diagram illustrating a specific example of the latch circuit. Differences between FIG. 14 and FIG. 18 will be described.

Latch circuit 11 illustrated in FIG. 18 has switch SW2 that can input signal data to INV3, and is a complementary input type latch circuit that can invert signal data and input inverted signal data to inverter INV2, and input signal data to inverter INV3.

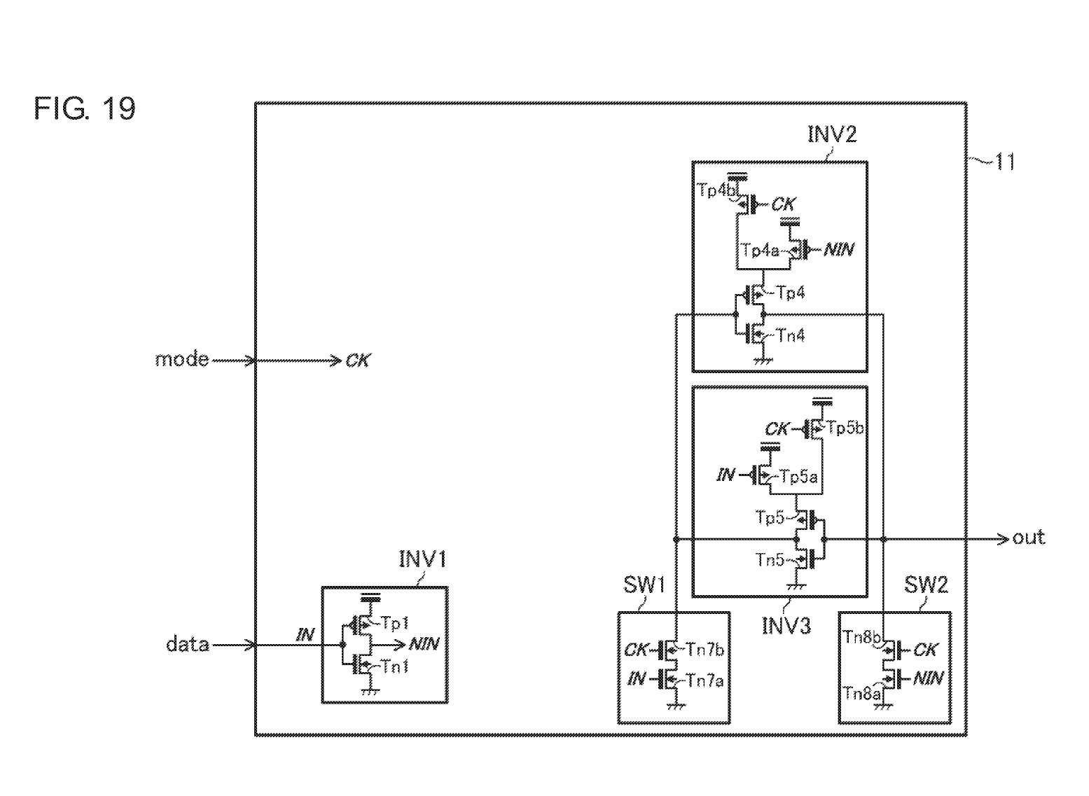

FIG. 19 is a detailed circuit diagram of FIG. 18. Differences between FIG. 17 and FIG. 19 will be mainly described. In FIG. 19, inside latch circuit 11, signal mode is represented as signal CK, and signal data is represented as signal IN.

Inverter INV1 is configured by PMOS transistor Tp1 and NMOS transistor Tn1, receives signal IN as signal data, and inverts signal IN to output signal NIN.

Switch SW1 can be configured by NMOS transistor Tn7a that has a gate which receives signal IN, and NMOS transistor Tn7b that has a gate which receives signal CK.

Switch SW2 can be configured by NMOS transistor Tn8a that has a gate which receives signal NIN, and NMOS transistor Tn8b that has a gate which receives signal CK.

Inverter INV2 can be configured by PMOS transistor Tp4a that has a gate which receives signal NIN, PMOS transistor Tp4b that has a gate which receives signal CK, and PMOS transistor Tp4 and NMOS transistor Tn4 that have gates connected to switch SW1.

Inverter INV3 can be configured by PMOS transistor Tp5a that has a gate which receives signal IN, PMOS transistor Tp5b that has a gate which receives signal CK, and PMOS transistor Tp5 and NMOS transistor Tn5 that has gates connected to switch SW2.

By thus configured complementary input type latch circuit 11, the value to be latched can be determined as a logical value in response to signal data.

Consequently, even when signal data is at an H level or at an L level, operation of latch circuit 11 becomes equivalent, the value to be latched can be easily determined as any of the H level and the L level. Additionally, signal reset becomes unnecessary. Respective inputs of switches SW1, SW2 may be reversed.

### —Configuration Example 4—

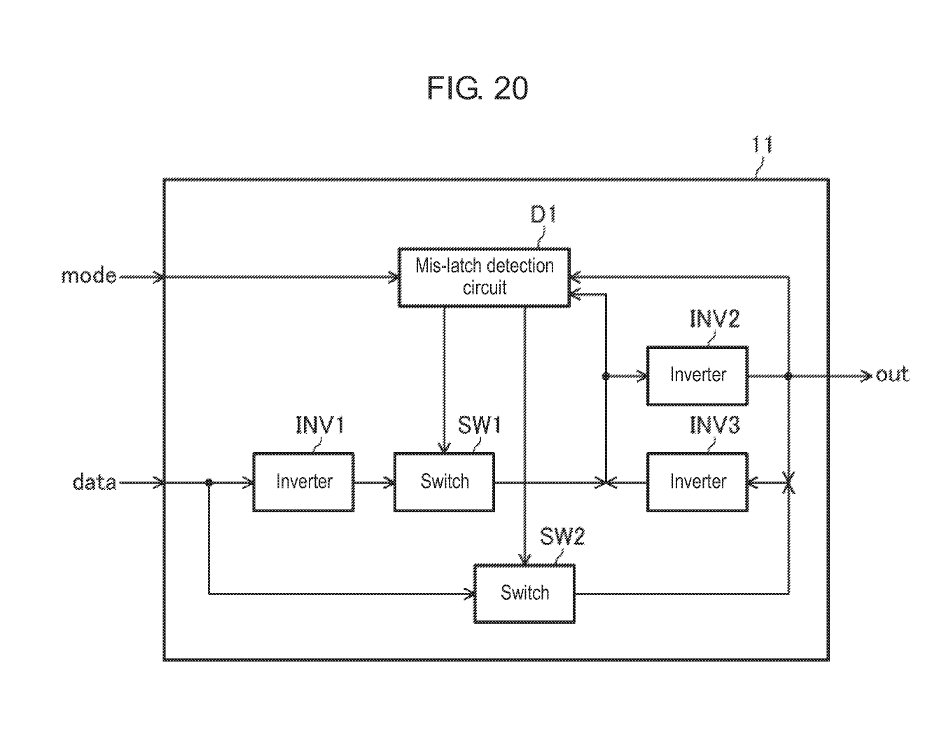

FIG. 20 is an example of another configuration diagram illustrating a specific example of the latch circuit. Differences between FIG. 18 and FIG. 20 will be described.

Latch circuit 11 illustrated in FIG. 20 is configured to be able to correct a latched value in a case where the latched value is intermediate potential. That is, latch circuit 11 is a self-reset type latch circuit that can reset a latched value to a value of signal data in a case where the latched value is intermediate potential.

Latch circuit 11 has mis-latch detection circuit D1 as a monitor circuit. Mis-latch detection circuit D1 monitors a value latched by inverters INV2, INV3. In a case where the latched value is intermediate potential, latch circuit 11 turns on switches SW1, SW2 regardless of a value of signal mode. Consequently, the value of signal data is written in latch configured by inverters INV2, INV3.

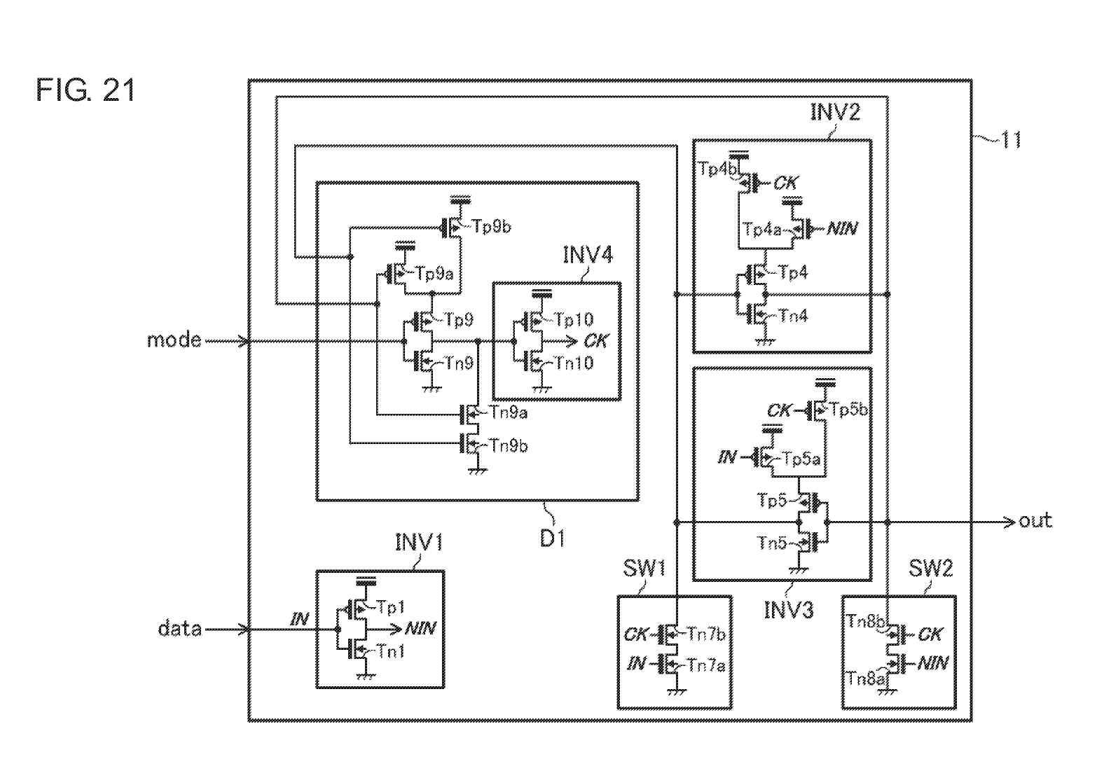

FIG. 21 is a detailed circuit diagram of FIG. 20. Differences between FIG. 19 and FIG. 21 will be mainly described.

In FIG. 21, mis-latch detection circuit D1 can be configured by PMOS transistors Tp9, Tp9a, Tp9b, NMOS transistors Tn9, Tn9a, Tn9b, and inverter INV4.

PMOS transistor Tp9 and NMOS transistor Tn9 configure an inverter, and receive and invert signal mode to output inverted signal.

Gates of PMOS transistor Tp9a and NMOS transistor Tn9a are connected to output of inverter INV2 and switch SW2.

Gates of PMOS transistor Tp9b and NMOS transistor Tn9b are connected to output of inverter INV3 and switch SW1.

Inverter INV4 can be configured by PMOS transistor Tp10 and NMOS transistor Tn10 that have gates which receive output of an inverter configured by PMOS transistor Tp9 and NMOS transistor Tn9.

By thus configured self-reset type latch circuit 11, even when signal reset is not required, and a latched value is intermediate potential, it is possible to correct the value to a value in response to signal data. Connection of NMOS transistors Tn9a, Tn9b may be reversed.

### Third Exemplary Embodiment

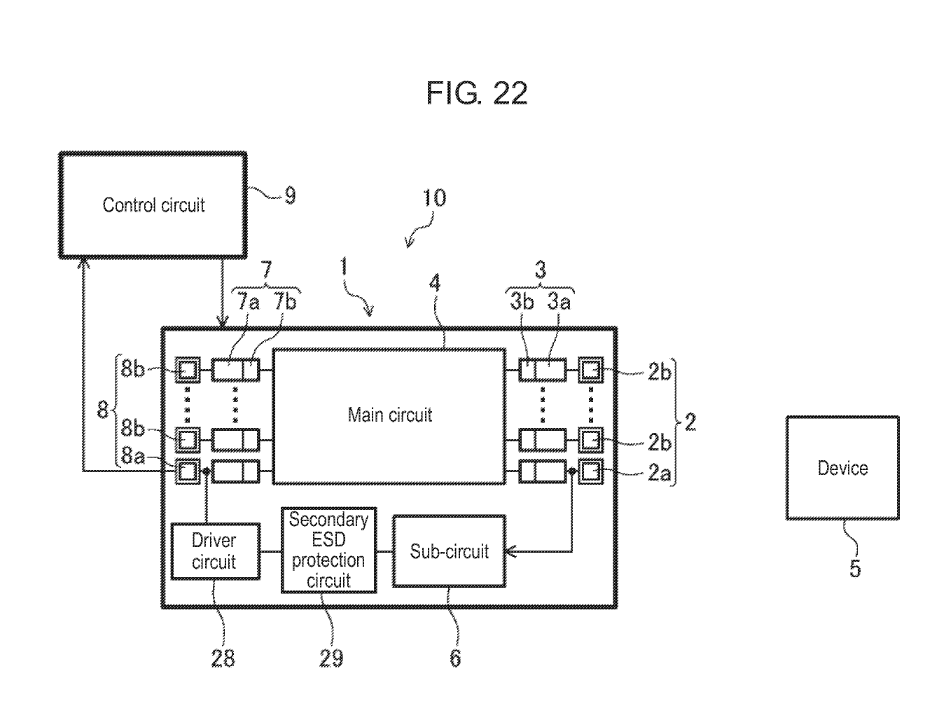

FIG. 22 is a configuration diagram illustrating a device detection system according to a third exemplary embodiment. Differences between the second exemplary embodiment and this exemplary embodiment will be mainly described.

LSI 1 illustrated in FIG. 22 has driver circuit 28, and secondary ESD protection circuit 29.

Driver circuit 28 buffers a signal from sub-circuit 6 to output the signal to pad 8a. Secondary ESD protection circuit 29 is provided between sub-circuit 6 and driver circuit 28.

Driver circuit 28 is preferably disposed at a position relatively close to pad 8a in order to keep quality of a signal output from sub-circuit 6 excellent, in a case where an input/output distance from detection pad 2a to pad 8a through sub-circuit 6 in LSI 1 is long. Additionally, in the case where the input/output distance is long, secondary ESD protection circuit 29 is preferably provided from the viewpoint of an ESD measure. Furthermore, a wire may be shielded between sub-circuit 6 and secondary ESD protection circuit 29.

As described above, according to this exemplary embodiment, it is possible to reduce power consumption of LSI 1, and it is possible to keep the quality of the signal from sub-circuit 6 to pad 8a excellent.

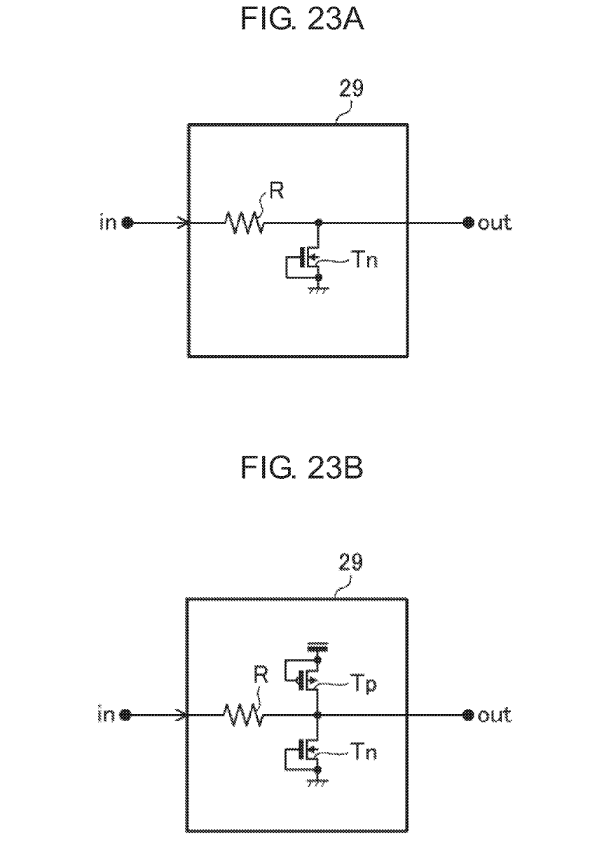

FIG. 23A, FIG. 23B each are a circuit diagram illustrating a specific example of the secondary ESD protection circuit. Secondary ESD protection circuit 29 illustrated in FIG. 23A has resistive element R that has a first end connected to input terminal in and second end connected to output terminal out, and NMOS transistor Tn connected between the second end of resistive element R and a ground.

Input terminal in is connected to output of sub-circuit 6, and output terminal out is connected to driver circuit 28.

Secondary ESD protection circuit 29 may be configured as illustrated in FIG. 23B. Specifically, PMOS transistor Tp may be connected between the second end of resistive element R and a power supply.

Sub-circuit 6 of this exemplary embodiment, and latch circuit 11 in sub-circuit 6 may be configured like each of the above configuration examples.

In each of the above exemplary embodiments, LSI 1 may be, for example, a bridge LSI of an SD card and a PCI-Express (Trademark).

In each of the above exemplary embodiments, device 5 may be a device other than an SD card.

The semiconductor integrated circuit according to the present disclosure is capable of reducing power consumption while being capable of continuously detecting presence of connection of a device, and therefore is particularly useful for an electronic device such as a personal computer and a mobile device, which is requested to extend a waiting time because of power saving in a standby mode.

What is claimed is:

1. A semiconductor integrated circuit configured to detect presence of connection of a device, and perform data communication with the device, the semiconductor integrated circuit comprising:
a plurality of first pads, each of which includes a detection pad for detecting presence of connection between the semiconductor integrated circuit and the device or a communication pad for performing data communication with the device;
a plurality of first IO (Input & Output) cells, each of which is connected to the detection pad or the communication pad, and has a high-withstand voltage device that receives a voltage of the detection pad or the communication pad, and a low-withstand voltage device that outputs a voltage stepped down from the voltage received by the high-withstand voltage device is stepped down;
a main circuit connected to the low-withstand voltage device, configured to detect the presence of the connection of the device based on a voltage output from at least one of the plurality of first IO cells connected to the detection pad, and configured to perform data communication with the device through at least one of the plurality of first IO cells connected to the communication pad in a case where the detection result shows that the device is connected; and
a sub-circuit connected to a high-withstand voltage device included in at least one of the plurality of first IO cells connected to the detection pad, and configured to detect the presence of the connection of the device based on a voltage of the detection pad.

2. The semiconductor integrated circuit according to claim 1, wherein
at least one of the plurality of first IO cells has a level shift circuit that steps down the voltage received by the high-withstand voltage device.

3. The semiconductor integrated circuit according to claim 1,
wherein the sub-circuit includes:
a latch circuit that latches the voltage of the detection pad when the main circuit is in a power-on state, and that holds the latched value when the power supply is in a power-off state;
an output circuit that determines the presence of the connection of the device based on the voltage of the detection pad and the value held by the latch circuit when the main circuit is in the power-off state, that activates output when the determination result shows that the device is connected, and that inactivates the output when the main circuit is in the power-on state; and
a state detection circuit that receives a state signal showing that the main circuit is in the power-on state or in the power-off state, and that outputs a value shown by the state signal to the latch circuit and the output circuit.

4. The semiconductor integrated circuit according to claim 3, wherein
the sub-circuit includes a storage circuit that stores the output of the output circuit.

5. The semiconductor integrated circuit according to claim 3, wherein
the sub-circuit includes a first setting circuit configured to set a value for inactivating the output of the output circuit, and
the output circuit is configured to inactivate the output of the output circuit in accordance with a set value of the first setting circuit.

6. The semiconductor integrated circuit according to claim 5, wherein
the main circuit includes a second setting circuit that sets a value to be set to the first setting circuit to the second setting circuit, and outputs the value to the first setting circuit, when receiving the value in a case where the main circuit is in the power-on state.

7. The semiconductor integrated circuit according to claim 4, wherein
the sub-circuit includes a first setting circuit configured to set a value for inactivating the output of the output circuit, and
the output circuit is configured to inactivate the output of the output circuit in accordance with a set value of the first setting circuit.

8. The semiconductor integrated circuit according to claim 7, wherein
the main circuit includes a second setting circuit that sets a value to be set to the first setting circuit to the second setting circuit, and outputs the value to the first setting circuit, when receiving the value in a case where the main circuit is in the power-on state.

9. The semiconductor integrated circuit according to claim 3, wherein
the sub-circuit includes a filter circuit that filters a voltage input from the detection pad to the latch circuit.

10. The semiconductor integrated circuit according to claim 3, further comprising an ESD (Electro-Static-Discharge) protection circuit connected to a route from the detection pad to the high-withstand voltage device of at least one of the plurality of first IO cells.

11. The semiconductor integrated circuit according to claim 3, wherein
the sub-circuit includes a pull-up circuit that pulls up the voltage of the detection pad in a case where the device is not connected to the semiconductor integrated circuit, and
the voltage of the detection pad is pulled down in a case where the device is connected to the semiconductor integrated circuit.

12. The semiconductor integrated circuit according to claim 3, wherein
the latch circuit includes:
first and second inverters that latch the voltage of the detection pad;
a first switch circuit that has an output connected to an input side of the first inverter, and turns on and off in accordance with the voltage of the detection pad and the state signal; and
a second switch circuit that has an output connected to an input side of the second inverter, and turns on and off in accordance with the voltage of the detection pad and the state signal.

13. The semiconductor integrated circuit according to claim 12, wherein
the latch circuit includes a monitor circuit that monitors potential latched by the first and second inverters, and turns on the first and second switch circuits in a case where the monitoring result shows that the latched potential is intermediate potential.

14. The semiconductor integrated circuit according to claim 1, wherein
the device is an SD (Secure Digital) card.

15. The semiconductor integrated circuit according to claim 1, wherein
the semiconductor integrated circuit is a bridge LSI (large scale integration) of an SD card and a PCI-Express.

16. The semiconductor integrated circuit according to claim 1, wherein
in a case where the device is connected, the detection pad is pulled down by a mechanical switch.

17. A device detection system comprising the semiconductor integrated circuit according to claim 1,
wherein the semiconductor integrated circuit includes:
at least one second IO cell having a low-withstand voltage device that receives a signal showing a detection result by the main circuit, and a high-withstand voltage device that outputs a voltage boosted from the voltage received by the low-withstand voltage device; and
a second pad that outputs the voltage supplied from the high-withstand voltage device of the at least one second IO cell to an outside of the semiconductor integrated circuit, and
an output as a detection result by the sub-circuit is connected to the high-withstand voltage device included in the at least one second IO cell connected to the second pad,
the device detection system further comprising a control circuit that performs on-control of power supplied to the main circuit in a case where a signal from the second pad shows that the device is connected.

18. The device detection system according to claim 17, wherein
the at least one of second IO cell has a level shift circuit that boosts the voltage received by the low-withstand voltage device.

19. The device detection system according to claim 17, wherein
the semiconductor integrated circuit includes:
a driver circuit that buffers an output of the sub-circuit and then outputs the buffered output to the second pad; and
a secondary ESD (Electro-Static-Discharge) protection circuit connected between the driver circuit and the sub-circuit.

20. The device detection system according to claim 17, wherein
the semiconductor integrated circuit has a normal mode in which the main circuit is in a power-on state, and a standby mode in which the main circuit is in a power-off state, and the sub-circuit detects the device, and
in the standby mode, the control circuit controls so as to bring the main circuit into the power-on state in a case where a signal from the detection pad as a detection result by the sub-circuit shows that the device is connected.
